(19) United States
(12) Patent Application Publication
(10) Pub. No.: US 2006/0171466 A1
(43) Pub. Date: Aug. 3, 2006

(54) Method and system for mosquito noise reduction

(76) Inventors: Brian Schoner, Freemont, CA (US); Darren Neuman, Palo Alto, CA (US)

Correspondence Address: MCANDREWS HELD & MALLOY, LTD, 500 WEST MADISON STREET, SUITE 3400, CHICAGO, IL, 60661, US

(21) Appl. No.: 11/087,491

(22) Filed: Mar. 22, 2005

Related U.S. Application Data
(60) Provisional application No. 60/648,302, filed on Jan. 28, 2005.

(51) Int. Cl. H04N 11/04; H04N 7/12; H04B 1/66; H04N 11/02

(52) U.S. Cl. 375/240.24; 375/240.29

(57) ABSTRACT

In a video system, a method and system for mosquito noise reduction are provided. Mosquito noise may be detected by determining a block variance parameter for an image block and a local variance parameter for a portion of the image block. The block variance parameter may be based on serially determined horizontal and vertical variance parameters. A clamping limit is also determined based on the block variance parameter, the local variance parameter, a relative weight parameter, and a mosquito core limit parameter. Pixels covered by the local variance may be filtered and the filtered output may be compared to the original pixel values to determine a difference parameter. Different filter values may be utilized for progressive and interlaced video. A mosquito noise reduction (MNR) difference parameter may be determined based on the difference parameter and the clamping limit and may be utilized to reduce mosquito noise artifacts.

### CROSS-REFERENCE TO RELATED APPLICATIONS/INCORPORATION BY REFERENCE

This patent application makes reference to, claims priority to and claims benefit from U.S. Provisional Patent Application Ser. No. 60/648,302, filed on Jan. 28, 2005.

This application makes reference to:
U.S. patent application Ser. No. ______ (Attorney Docket No. 16323US02) filed Mar. 18, 2005;
U.S. patent application Ser. No. ______ (Attorney Docket No. 16487US02) filed ______, 2005; and
U.S. patent application Ser. No. ______ (Attorney Docket No. 16488US02) filed ______, 2005.

The above stated applications are hereby incorporated herein by reference in their entirety.

### FIELD OF THE INVENTION

Certain embodiments of the invention relate to video processing. More specifically, certain embodiments of the invention relate to a method and system for mosquito noise reduction.

### BACKGROUND OF THE INVENTION

Advances in compression techniques for audio-visual information have resulted in cost effective and widespread recording, storage, and/or transfer of movies, video, and/or music content over a wide range of media. The Moving Picture Experts Group (MPEG) family of standards is among the most commonly used digital compressed formats. A major advantage of MPEG compared to other video and audio coding formats is that MPEG-generated files tend to be much smaller for the same quality. This is because MPEG uses very sophisticated compression techniques. However, MPEG compression may be lossy and, in some instances, it may distort the video content. In this regard, the more the video is compressed, that is, the higher the compression ratio, the less the reconstructed video resembles the original information. Some examples of MPEG video distortion are a loss of texture, detail, and/or edges. MPEG compression may also result in ringing on sharper edges and/or discontinuities on block edges. Because MPEG compression techniques are based on defining blocks of video image samples for processing, MPEG compression may also result in visible “macroblocking” that may result due to bit errors. In MPEG, a macroblock is the area covered by a 16×16 array of luma samples in a video image. Luma may refer to a component of the video image that represents brightness. Moreover, noise due to quantization operations, as well as aliasing and/or temporal effects may all result from the use of MPEG compression operations.

When MPEG video compression results in loss of detail in the video image it is said to “blur” the video image. In this regard, operations that are utilized to reduce compression-based blur are generally called image enhancement operations. When MPEG video compression results in added distortion on the video image it is said to produce “artifacts” on the video image. For example, the term “mosquito noise” may refer to MPEG artifacts that may be caused by the quantization of high spatial frequency components in the image. Mosquito noise may also be referred to as “ringing” or “Gibb's effect.”

Some of the characteristics of mosquito noise may result from the fact that it is an artifact of the 8×8 block Discrete Cosine Transform (DCT) operation in MPEG compression. While generally confined to a particular 8×8 block of video samples, in some instances, motion compensation may result in mosquito noise beyond the block boundary. Mosquito noise commonly appears near luma edges, making credits, text, and/or cartoons particularly susceptible to this form of artifact. Mosquito noise may be more common, and generally more severe, at low bit rates. For example, mosquito noise may be more severe when macroblocks are coded with a higher quantization scale and/or on a larger quantization matrix.

Mosquito noise may tend to appear as very high spatial frequencies within the processing block. In some instances, when the input video to the MPEG compression operation has any motion, the mosquito noise generated may tend to vary rapidly and/or randomly resulting in flickering noise. Flickering noise may be particularly objectionable to a viewer of the decompressed video image. In other instances, when the input video to the MPEG compression operation is constant, the mosquito noise that results is generally constant as well. Horizontal edges tend to generate horizontal ringing while vertical edges tend to generate vertical ringing. While mosquito noise may also occur in the color components or chroma of a video image, it may generally be less of a problem since it is less objectionable to a viewer of the decompressed video image.

There have been attempts to provide normative approaches for reducing the effects of mosquito noise. For example, the MPEG4 specification ISO/IEC 14496-2:1999/Amd.1:2000(E) Annex F comprises a state-of-the-art mosquito noise filter, which is also called a deringing filter, which may be utilized to filter out mosquito noise. However, the MPEG4-based deringing filter may have several limitations. For example, the MPEG4 deringing filter may have a hard threshold based on the binary index operation bin(h,v). Accordingly, small changes in pixel values may cause the filter to turn ON or OFF, causing objectionable pixel flickering. The MPEG4 deringing filter may only be applied to 8×8 blocks. This may limit the utility of the deringing filter since under high-motion and/or low bit rate conditions motion compensation may move mosquito noise beyond the transform block edges. The deringing filter kernel is symmetrical vertically and horizontally and as a result, the deringing filter may not correct for interlaced video, where the vertical pixel or sample distance is twice the horizontal pixel distance. Another limitation arises because the detection algorithm utilized by the MPEG4 deringing filter may often overfilter or underfilter video images. Moreover, the detection algorithm may utilize a 10×10 block of pixels or samples to detect mosquito noise and this large block size may be very expensive for raster-scan implementations. Future solutions to the presence of these types of video compression artifacts may need to provide cost effective and easy to implement reductions in mosquito noise without any perceptible degradation in video quality.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for mosquito noise reduction, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates various aspects of mosquito noise in video systems that may be utilized in accordance with an-embodiment of the invention.

FIG. 2 is a block diagram of an exemplary video processing system that may be utilized for mosquito noise reduction (MNR) and/or block noise reduction (BNR), in accordance with an embodiment of the invention.

FIG. 3 is a block diagram of an exemplary top-level partitioning of the DNR, in accordance with an embodiment of the invention.

FIG. 4A illustrates an exemplary operation of line stores in a high definition (HD) mode, in accordance with an embodiment of the invention.

FIG. 4B illustrates an exemplary operation of line stores in a standard definition (SD) mode, in accordance with an embodiment of the invention.

FIG. 5 illustrates an exemplary storage of line store luma output lines in the pixel buffer, in accordance with an embodiment of the invention.

FIG. 6 illustrates exemplary contents in the pixel buffer for a current image block at an instant in time, in accordance with an embodiment of the invention.

FIG. 7 is a block diagram illustrating an exemplary BV MNR block, in accordance with an embodiment of the invention.

FIG. 8 illustrates exemplary block variance parameter values at various image block processing stages, in accordance with an embodiment of the invention.

FIG. 9 illustrates exemplary use of neighboring image blocks when determining the block variance parameter, in accordance with an embodiment of the invention.

FIG. 10 is a block diagram illustrating an exemplary MNR filter block, in accordance with an embodiment of the invention.

FIGS. 11A-11B illustrate an exemplary portion of the current image block for determining a local variance parameter, in accordance with an embodiment of the invention.

FIG. 12 is a flow diagram illustrating exemplary steps for the determination of an MNR difference parameter, in accordance with an embodiment of the invention.

### DETAILED DESCRIPTION OF THE INVENTION

Certain embodiments of the invention may be found in a method and system for mosquito noise reduction. Mosquito noise may be detected by determining a block variance parameter for an image block and a local variance parameter for a portion of the image block. The block variance parameter may be based on serially determined horizontal and vertical variance parameters. A clamping limit is also determined based on the block variance parameter, the local variance parameter, a relative weight parameter, and/or a mosquito core limit parameter. Pixels covered by the local variance may be filtered and the filtered output may be compared to the original pixel values to determine a difference parameter. Different filter values may be utilized for progressive and interlaced video. A mosquito noise reduction (MNR) difference parameter may be determined based on the difference parameter and the clamping limit and may be utilized to reduce mosquito noise artifacts. Note that the following discussion will generally use the terms “image” and “picture” interchangeably. Accordingly, notions of difference between the terms “image” and “picture” should not limit the scope of various aspects of the present invention.

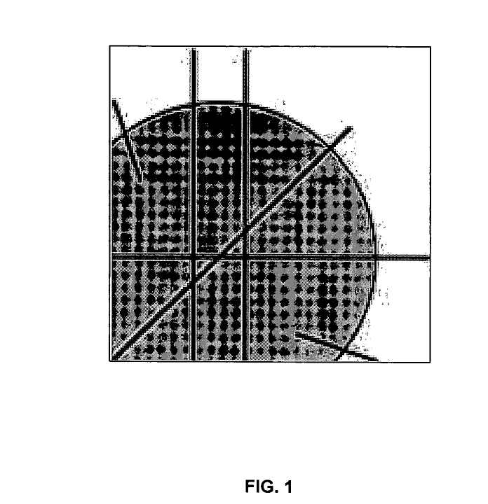

FIG. 1 illustrates various aspects of mosquito noise in video systems that may be utilized in accordance with an embodiment of the invention. Referring to FIG. 1, there is shown a video image comprising typical mosquito noise. Mosquito noise is block based and tends to occur near sharp edges. In some instances, horizontal edges may cause horizontal ringing and vertical edges may cause vertical ringing. Vertical and horizontal ringing may be additive, for example. When the edges are diagonal, a checkerboard pattern may occur near the diagonal edge. The checkerboard patterns may be stronger near an intersection between a horizontal and a vertical edge the ringing that occurs in horizontal or vertical edges. Moreover, mosquito noise may not fade away from edges as the fast fourier transform (FFT) ringing that occurs as a result of Gibb's phenomenon. In some instances, the largest mosquito noise spike may actually occur farthest from the edge.

Because mosquito noise may be related to the MPEG block structure, several factors, including field or frame coding of macroblocks, chroma coding format, for example, 4:4:4/4:2:2/4:2:0, and field or frame raster scan from a feeder may need to be considered for an effective noise reduction implementation. For example, in MPEG2 main profile and in MPEG2 simple profile, chroma may be coded as 4:2:0 and may generally have mosquito noise on 16×16 image blocks or macroblocks. The original video content may be coded into macroblocks as field data or as frame data. The original video may be coded as frame pictures by utilizing a field or frame DCT coding. When the frame DCT coding is utilized, an 8×8 luma block may comprise 4 lines from each field. When the field DCT coding is utilized, an 8×8 luma block may comprise 8 lines from a single field. The original video may also be coded as field pictures in which case an 8×8 luma block may comprise 8 lines from a single field.

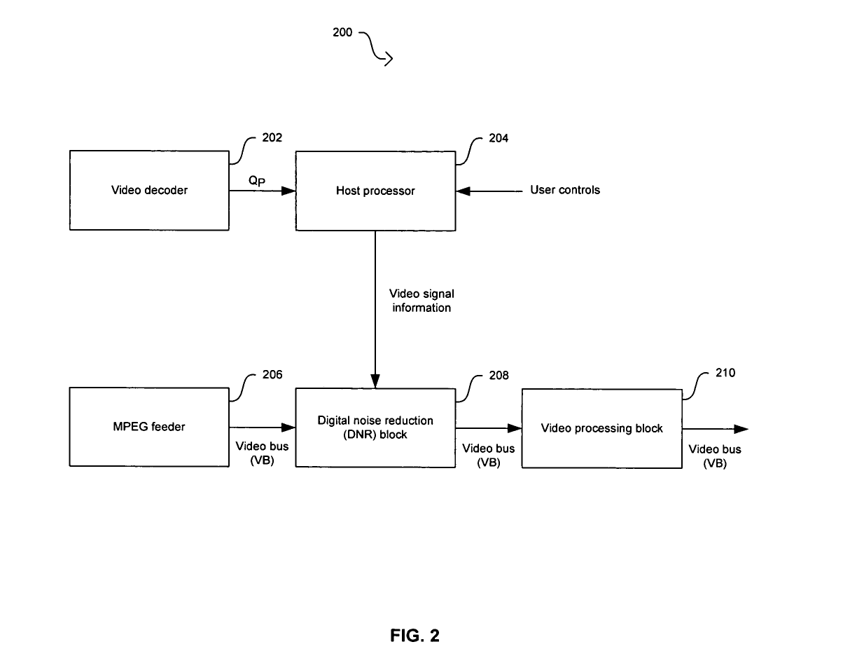

FIG. 2 is a block diagram of an exemplary video processing system that may be utilized for mosquito noise reduction (MNR) and/or block noise reduction (BNR), in accordance with an embodiment of the invention. Referring to FIG. 2, there is shown a video processing system 200 comprising a video decoder 202, a processor 204, an MPEG feeder 206, a digital noise reduction (DNR) block 208, and a video processing block 210. The video decoder 202 may comprise suitable logic, circuitry, and/or code that may be adapted to decode compressed video information. The host processor 204 may comprise suitable logic, circuitry, and/or code that may be adapted to process quantization information, Qp, received from the video decoder 202 and/or user control information received from at least one additional device or processing block. The host processor 204 may be adapted to generate video signal information that corresponds to a current picture based on the processed quantization information and/or user control information. The generated video signal information may comprise, for example, threshold settings, indications of whether a video field is a top field or a bottom field, indications of whether the video signal is interlaced or progressive, and/or the size of the video image. The host processor 204 may transfer the video signal information to the DNR block 208. In some instances, at least a portion of the video signal information may be received by the DNR block 208 via a register direct memory access (DMA).

The MPEG feeder 206 may comprise suitable logic, circuitry, and/or code that may be adapted to transfer a plurality of MPEG-coded images to the DNR block 208 via a video bus (VB), for example. In this regard, the VB may utilize a specified format for transferring images from one processing or storage block to another processing or storage block. The DNR block 208 may comprise suitable logic, circuitry, and/or code that may be adapted to reduce some artifacts that may result from MPEG coding. In this regard, the DNR block 208 may be adapted to process MPEG-coded images to reduce mosquito noise. The processing performed by the DNR block 208 may be based on the contents of a current video image and on the video signal information corresponding to that current video image transferred from the host processor 204. The video signal information may be programmed or stored into registers in the DNR block 208 during the vertical blanking interval, for example. This programming approach may reduce any unpredictable behavior in the DNR block 208. The DNR block 208 may be adapted transfer the processed MPEG-coded images to the video processing block 210 via the VB. The video processing block 210 may comprise suitable logic, circuitry, and/or code that may be adapted to perform various image processing operations such as scaling and/or deinterlacing, for example, on the processed MPEG-coded images received from the DNR block 208.

When the pictures from the MPEG feeder 206 are coded as field pictures they may be transferred to the DNR block 208 as field pictures. When the pictures from the MPEG feeder 206 are coded as frame pictures they may be transferred to the DNR block 208 as frame or field pictures in accordance with the video stream format and/or the display. In this regard, frame pictures that are transferred to the DNR block 208 as field pictures may have mosquito noise on 4 vertical line boundaries.

The DNR block 208 may also be adapted to provide post-processing operations for the Advanced Video Codec (AVC) and/or the Windows Media (VC9) codec. The deblocking or artifact reduction operations performed by the DNR block 208 may be relaxed for AVC and VC9 because they specify in-loop deblocking filters. For example, AVC transforms may exhibit less ringing that the 8×8 DCT utilized in MPEG. Moreover, while AVC and VC9 allow image block sizes smaller than 8×8 to be utilized, processing at the sub-block level may present some difficulties and the DNR block 208 may perform deblocking filtering for AVC and VC9 without sub-block processing.

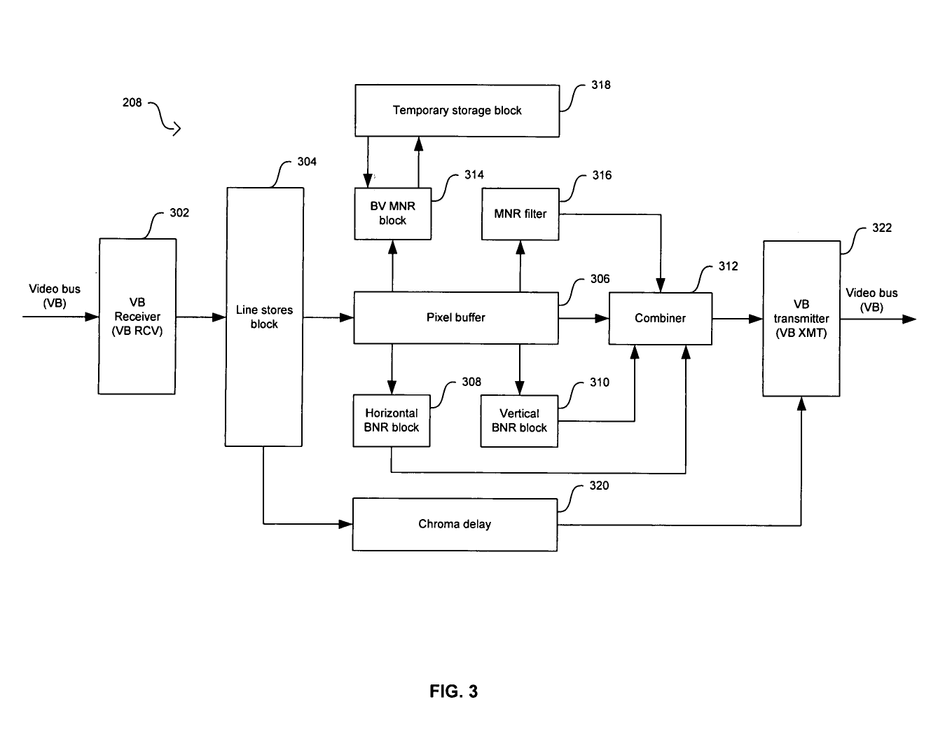

FIG. 3 is a block diagram of an exemplary top-level partitioning of the DNR, in accordance with an embodiment of the invention. Referring to FIG. 3, the DNR block 208 described in FIG. 2 may comprise a VB receiver (VB RCV) 302, line stores block 304, a pixel buffer 306, a combiner 312, a block variance (BV) mosquito noise reduction (MNR) block 314, an MNR filter 316, a temporary storage block 318, a chroma delay block 720, and a VB transmitter (VB XMT) 322. In some instances, the DNR block 208 may also support block noise reduction and may comprise a horizontal block noise reduction (BNR) block 308 and a vertical BNR block 310 for that purpose.

The VB RCV 302 may comprise suitable logic, circuitry, and/or code that may be adapted to receive MPEG-coded images in a format that is in accordance with the bus protocol supported by the VB. The VB RCV 302 may also be adapted to convert the received MPEG-coded video images into a different format for transfer to the line stores block 304. The line stores block 304 may comprise suitable logic, circuitry, and/or code that may be adapted to convert raster-scanned luma data from a current MPEG-coded video image into parallel lines of luma data. The line stores block 304 may be adapted to operate in a high definition (HD) mode or in a standard definition (SD) mode. Moreover, the line stores block 304 may also be adapted to convert and delay-match the raster-scanned chroma information into a single parallel line.

The pixel buffer 306 may comprise suitable logic, circuitry, and/or code that may be adapted to store luma information corresponding to a plurality of pixels from the parallel lines of luma data generated by the line stores block 304. For example, the pixel buffer 306 may be implemented as a shift register. In accordance with one embodiment of the invention, wherever the DNR block 208 is also adapted to support block noise reduction, the pixel buffer 306 may be communicatively coupled to the MNR block 314, the MNR filter 316, the horizontal BNR block 308, and the vertical BNR block 310 to save on, for example, floating point operations per second (flops).

The BV MNR block 314 may comprise suitable logic, circuitry, and/or code that may be adapted to determine a block variance parameter for image blocks of the current video image. The BV MNR block 314 may utilize luma information from the pixel buffer 306 and/or other processing parameters. The temporary storage block 318 may comprise suitable logic, circuitry, and/or code that may be adapted to store temporary values determined by the BV MNR block 314. The MNR filter 316 may comprise suitable logic, circuitry, and/or code that may be adapted to determine a local variance parameter based on a portion of the image block being processed and to filter the portion of the image block being processed in accordance with the local variance parameter. The MNR filter 316 may also be adapted to determine a MNR difference parameter that may be utilized to reduce mosquito noise artifacts.

The combiner 312 may comprise suitable logic, circuitry, and/or code that may be adapted to combine the original luma value of an image block pixel from the pixel buffer 306 with a luma value that results from the filtering operation performed by the MNR filter 316. The chroma delay 320 may comprise suitable logic, circuitry, and/or code that may be adapted to delay the transfer of chroma pixel information in the chroma data line to the VB XMT 322 to substantially match the time at which the luma data generated by the combiner 312 is transferred to the VB XMT 322. The VB XMT 322 may comprise suitable logic, circuitry, and/or code that may be adapted to assemble noise-reduced MPEG-coded video images into a format that is in accordance with the bus protocol supported by the VB.

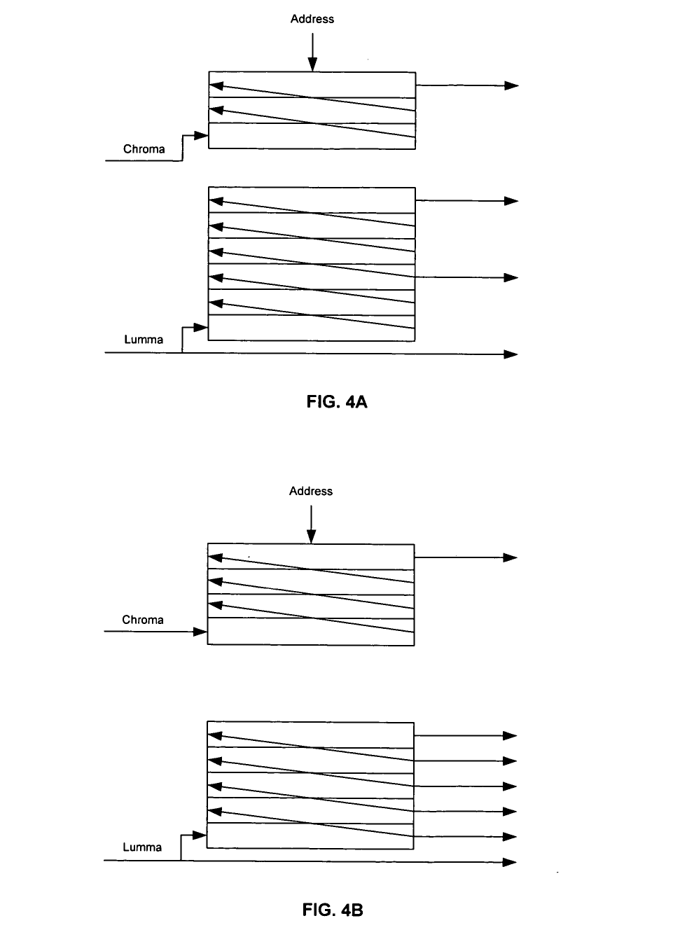

FIG. 4A illustrates an exemplary operation in a high definition (HD) mode, in accordance with an embodiment of the invention. Referring to FIG. 4A, the line stores block 304, described in FIG. 3, may be adapted to operate in a mode that converts HD image sources into output parallel lines. In this regard, the line stores block 304 may be adapted to generate three output parallel luma lines and one output chroma line, for example. The line stores block 304 may need to know the raster position relative to the image block boundaries. For example, the host processor 204 or a register DMA may provide offset values when a first raster pixel does not correspond to an image block boundary.

In one embodiment of the invention, the line stores block 304 may be implemented as a 768×72 memory with a single address. Both luma and chroma data may be wrapped from the output to the input as shown in FIG. 4A. In this regard, the luma data is expanded into three parallel lines and the chroma data is delay-matched by one line. For example, for a 1920×1080i HD video signal, where i refers to interlaced video, the address may count modulo 640 and the data values may wrap around three times, or 3×640=1920. In another example, for a 1280×720p HD video signal, where p refers to progressive video, the address may count modulo 426 and the data values may wrap around three times, or 3×426=1278, with an error of two pixels. In this regard, additional registers and/or storage elements may be utilized for each line out to compensate for the error. The line stores block 304 may be adapted to process all picture sizes up to, for example, 1920 pixels width.

FIG. 4B illustrates an exemplary operation in a standard definition (SD) mode, in accordance with an embodiment of the invention. Referring to FIG. 4B, the line stores block 304 described in FIG. 3 may be adapted to operate in a mode that converts SD image sources into output parallel lines. In this regard, the line stores block 304 may be adapted to generate six output parallel luma lines and one output chroma line, for example. The line stores block 304 may need to know the raster position relative to the image block boundaries. For example, the host processor 204 or a register DMA may provide offset values when a first raster pixel does not correspond to an image block boundary.

In one embodiment of the invention, the line stores block 304 may be implemented as a 768×72 memory with a single address. Both luma and chroma data may be wrapped from the output to the input as shown in FIG. 4B. In this regard, the luma data is expanded into six parallel lines and the chroma data is delay-matched by four lines. For example, for a 704×480i SD video signal, where i refers to interlaced video, the address may count modulo 720 and the data values may not need to wrap around and produce an error of 16 pixels. In this regard, additional registers and/or storage elements may be utilized for each line out to compensate for the error. The line stores block 304 may be adapted to process all picture sizes up to, for example, 1920 pixels width.

The line stores block 304, whether operating in an HD mode or an SD mode, may also be adapted to provide line information, image block information, and/or pixel location information to the pixel buffer 306 and/or the chroma delay 320. For example, the line stores block 304 may indicate the position, location, and/or coordinates of a pixel in an 8×8 image block. The position, location, and/or coordinates may be adjusted based on any offset values. In another example, the line stores block 304 may indicate the start and/or end of an output line and/or the start and/or end of a current picture. Providing information to the pixel buffer 306 and/or the chroma delay 320 may be performed on a clock cycle basis, for example.

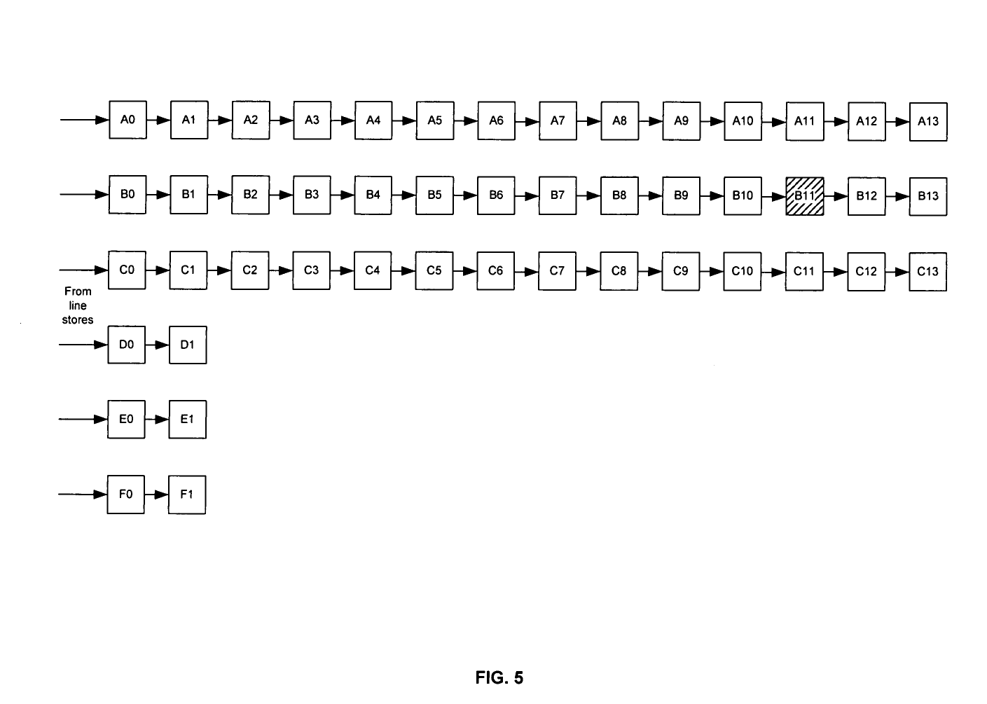

FIG. 5 illustrates an exemplary storage of line store luma output lines in the pixel buffer, in accordance with an embodiment of the invention. Referring to FIG. 5, there is shown an exemplary organization of the stored luma output lines generated by the line stores block 304 in the pixel buffer 306 in FIG. 3. The topmost line of pixels labeled A0 through A13 may correspond to a previous output line. The line of pixels labeled B0 through B13 may correspond to a current output line. In this regard, the pixel labeled B11 may correspond to a current pixel being processed. When the line stores block 304 operates in an HD mode, the bottommost line of pixels to be processed may be the line of pixels labeled C0 through C13. When the line stores block 304 operates in an SD mode, the bottommost line of pixels to be processed may be the line of pixels labeled F0 through F1. In both cases the bottommost line of pixels may correspond to a next output line.

The lines of pixels labeled D0 through D1, E0 through E1, and F0 through F1 may be utilized for the SD mode of operation where six luma output lines may be generated by the line stores block 304 in FIG. 3. Moreover, two flops may be sufficient for handling these lines. Because pictures may be raster scanned from left to right, pixels in column 13, that is, pixels A13, B13, and C13, in the exemplary organization shown in FIG. 5 may correspond to the leftmost pixels in the pixel buffer 306 while pixels in column 0, that is, pixels A0, B0, and C0, may correspond to the rightmost pixels in the pixel buffer 306. In some instances, at least one of the register values as described in the exemplary organization shown in FIG. 5 may be removed to optimize the operation of the pixel buffer 306.

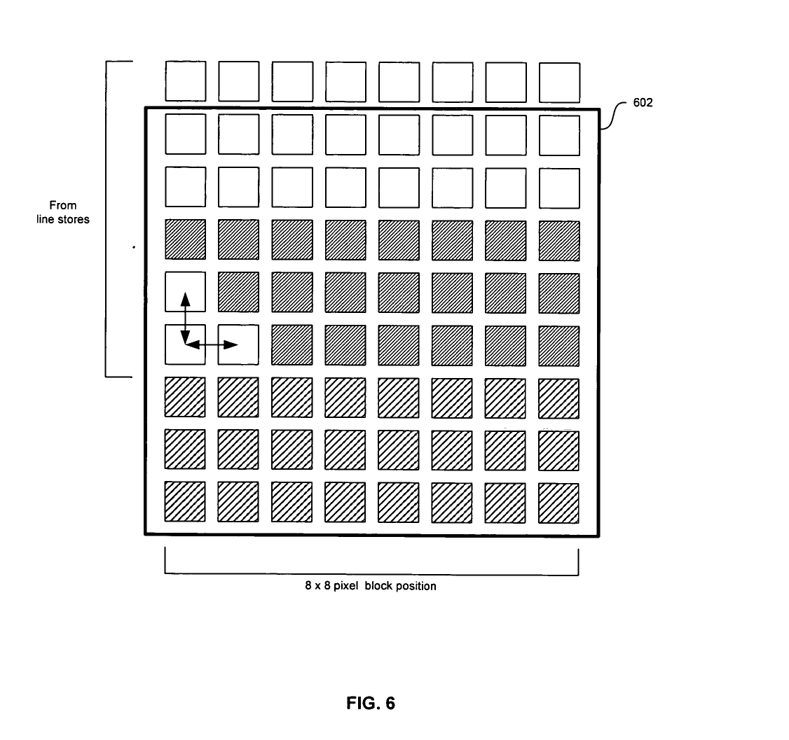

FIG. 6 illustrates exemplary contents in the pixel buffer for a current image block at an instant in time, in accordance with an embodiment of the invention. Referring to FIG. 6, there is shown an image block 602 that comprises 64 pixel values. The top six lines of pixels may correspond to pixels in the pixel buffer 306 from the six luma output lines generated by the line stores block 304 when operating in a SD mode. The lower three lines of pixels shown by widely spaced hashed lines may correspond to subsequent luma output lines that have not been received by the pixel buffer 306. Pixel values in the pixel buffer 306 may be utilized to perform serial processing operations. For example, the arrows shown in FIG. 6 illustrate vertical and horizontal neighboring pixels as they shift through the pixel buffer 304. Because the pixels shown by narrowly spaced hashed lines may not be needed to perform serial processing operations, they may not need to be implemented in the pixel buffer 304.

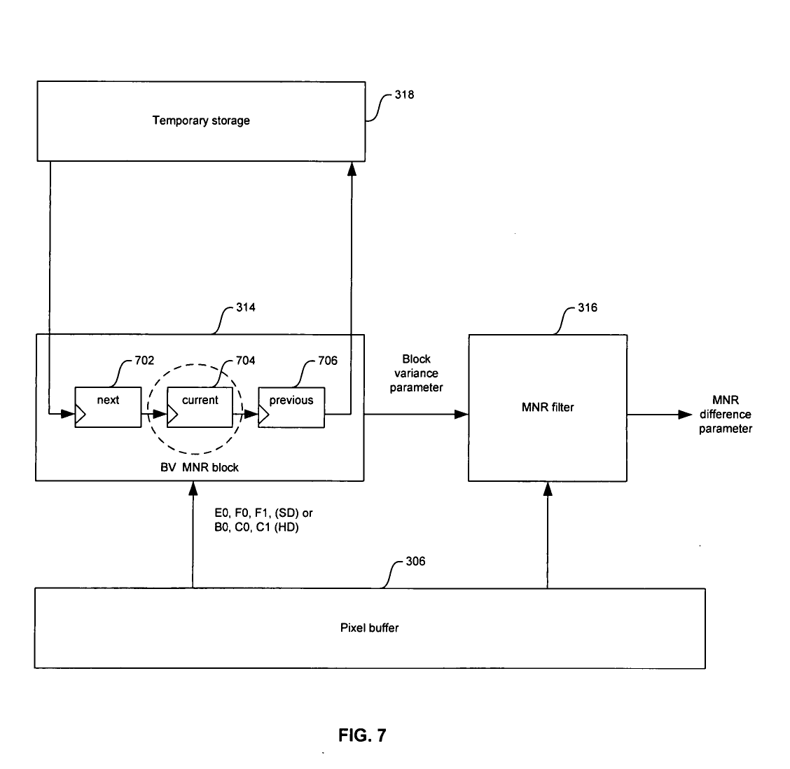

FIG. 7 is a block diagram illustrating an exemplary BV MNR block and an exemplary MNR filter, in accordance with an embodiment of the invention. Referring to FIG. 7, there is shown the pixel buffer 306, the BV MNR block 314, the temporary storage block 318, and the MNR filter 316. The BV MNR 314 may comprise, for example, a next block 702, a current block 704, and a previous block 706.

The BV MNR block 314 may be adapted to perform luma edge detection within an image block and to determine a block variance parameter (block_var) based on the detected edges. In this regard, the length of the edge and/or the number of luma edges inside an image block may not determine the strength of the mosquito noise. For example, an image block with a single-pixel edge may have as much, or sometimes more, mosquito noise than an image block with an eight-pixel edge. However, the sharpness of the luma edge may determine the strength of the mosquito noise. For example, gently sloping contents in an image block may not generate mosquito noise.

The BV MNR block 314 may determine the block variance parameter by serially calculating and/or determining a horizontal variance parameter (h_var) and/or a vertical variance parameter (v_var). The value of h_var may correspond to the maximum left/right difference between neighboring pixels in an image block. The value of v_var may correspond to the maximum top/bottom difference between neighboring pixels in an image block. The values for h_var and v_var may be reset to a default value at the start of each block for SD pictures or may be scaled from previously determined values for HD pictures. In this regard, a reset default value may be zero. Referring to the pixel labels as shown in FIG. 5 for the pixel buffer 306, for SD pictures the horizontal and vertical variance parameter may be determined by:
h_var=MAX(h_var, abs(F0−F1)), and
v_var=MAX(v_var, abs(E0−F0)),
where the values for h_var and v_var inside the MAX operations correspond to the maximum h_var and maximum v_var values previously determined for the image block respectively. For HD pictures the horizontal and vertical variance parameter may be determined by:
h_var=MAX(h_var, abs(C0−C1)), and
v_var=MAX(v_var, abs(B0−C0)),
where the values for h_var and v_var inside the MAX operations correspond to the maximum h_var and maximum v_var values previously determined for the image block respectively. The determination of h_var and v_var may be performed serially and the pixels that correspond to the labels E0, F0, F1, B0, C0, and/or C1 may change as the data is shifted through the pixel buffer 306. The values of h_var and v_var may be calculated utilizing pixels within the image block. In this regard, the next block 702, the current block 704, and the previous block 796 in the BV MNR block 314 may be adapted to serially determine the h_var and v_var values for all columns in the picture by storing and/or receiving h_var and v_var values into the temporary storage 318.

Once the values for h_var and v_var have been determined for an entire image block, the block_var may be determined based on value proportional to the sum of h_var and v_var. For example, the value of the block variance parameter may be expressed by block_var=0.75*(h_var+v_var). In some instances, the values of h_var and v_var are based on only a portion of the image block because the pixel buffer 306 has not received all pixels that correspond to that image block. When all the pixels for an image block are not available, the block_var value may be determined based on current available values for v_var and h_var. When block_var is determined based on all the pixels in the image block it may be referred to as a complete block_var. When block_var is determined based on a portion of the pixels in the image block it may be referred to as a partial block_var. The BV MNR block 314 may transfer the value of block_var to the MNR filter 316. The MNR filter 316 may determine an MNR difference parameter based on the block_var value transferred from the BV MNR block 314.

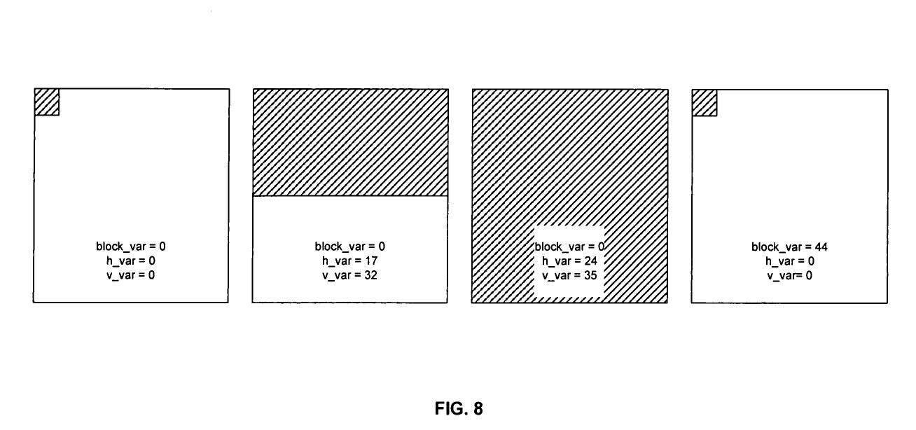

FIG. 8 illustrates exemplary block variance parameter values at various image block processing stages, in accordance with an embodiment of the invention. Referring to FIG. 8, at a given time during the processing of an image block a different number of pixels may be available at the pixel buffer 306. For example, when few pixels are available, that is, when most of the pixels available are near the top of an image block, a partial or current block_var may be determined based on the currently available values for h_var and v_var. When all the pixels in the image block are available, the complete block_var value may be determined based on the maximum left/right and maximum top/bottom differences between neighboring pixels for the entire image block.

The block_var stage described by the leftmost image block shown in FIG. 8 may correspond to a first stage when a first pixel in an current image block is being processed and all parameter values for the image block have been initialized and/or reset to zero. The current or partial block_var value for this first stage may be determined as block_var=0.75*(0+0)=0. The next image block shown in FIG. 8 may correspond to a second stage of the current image block when, as the current image block is raster scanned, values for h_var and v_var may be determined and may be stored in, for example, the temporary storage 318 in FIG. 3. In the exemplary second stage shown, the current value for h_var is 17 and the current value for v_var is 32. The value for the complete block_var remains at the reset value and the value for a current or partial block_var may be determined as block_var=0.75*(17+32)=37 with rounding.

The next image block shown in FIG. 8 may correspond to a third stage when the whole current image block has been scanned and the value for h_var is 24 and the value for v_var is 35. From these values the value of the current block_var for the entire current image block may be determined by block_var=0.75*(24+35)=44 with rounding. The value of the complete block_var remains at the reset value until replaced with the determined value of the current block_var. The next image block shown in FIG. 8 may correspond to a fourth stage when raster scanning of a next image block begins and the current value for h_var and current value for v_var are reset and the value for the complete block_var is the one determined for the current image block after the third stage was completed. In this regard, the next image block may refer to the next vertical image block in the column comprising the current image block. For the fourth stage, the value for a current or partial block_var may be determined as block_var=0.75*(0+0)=0.

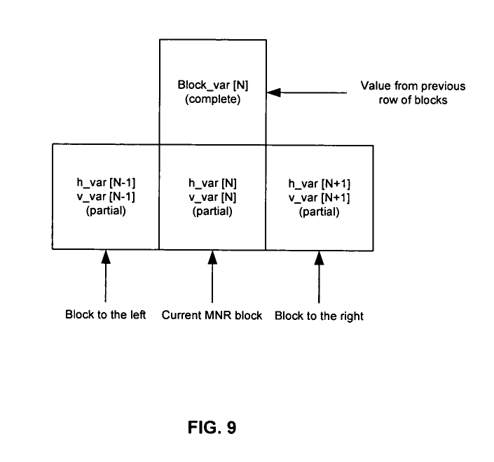

FIG. 9 illustrates exemplary use of neighboring image blocks when determining the block variance parameter, in accordance with an embodiment of the invention. Referring to FIG. 9, there is shown a current mosquito noise reduction (MNR) image block with adjacent image blocks in the same row or current image block row and an adjacent image block in the previous image block row. In some instances, luma edges may extend over a plurality of image blocks in a video picture. Because a previous image block row in the video picture may comprise information regarding at least one luma edge that may also extend into the current image block being processed, it may be useful to provide an approach that allows for this information to be considered in determining the block variance parameter of the current image block. Similarly, image blocks from the current image block row may comprise information regarding at least one luma edge that may also extend into the current image block being processed. In this regard, at least one image block to the right (N+1) and/or at least one image block to the left (N−1) of the current image block (N) in the current image block row may be considered, where N indicates the current image block column. Moreover, at least one image block in the previous image block row may also be considered.

When determining the block_var value for a current image block the block_var value for the image blocks in a previous image block row may have been determined already. In this regard, the current block_var for the current image block may correspond to a partial block_var when not all the pixels for the current image block are available from the pixel buffer 306 or may correspond to a complete block_var when all the pixels for the current image block are available from the pixel buffer 306. For a partial block_var value in the current image block, the effective block variance parameter for the current image block may be determined by the expression
block_var=MAX[block_var,
block_var_left*m_merge/4,
block_var_right*m_merge/4,
block_var_top*m_merge/4],
where the block_var value inside the MAX operation corresponds to a partial block_var of the current image block, block_var_left corresponds to a partial block_var of the image block to the left of the current image block, block_var_right corresponds to the partial block_var of the image block to the right of the current image block, block_var_top corresponds to a partial block_var of the image block on top of the current image block, m_merge corresponds to a mosquito noise merge parameter, and the number 4 is an exemplary scaling factor. The value of m_merge may range from 0 to 4, for example and may be programmable.

For a complete block_var value in the current image block, the effective block variance parameter for the current image block may be determined by the expression
block_var=MAX[block_var,
block_var_left*m_merge/4,
block_var_right*m_merge/4],
where the block_var value inside the MAX operation corresponds to a complete block_var of the current image block, block_var_left corresponds to a complete block_var of the image block to the left of the current image block, block_var_right corresponds to a complete block_var of the image block to the right of the current image block, m_merge corresponds to the mosquito noise merge parameter, and the number 4 is an exemplary scaling factor.

The approach described in relation to FIG. 9 may not be limited to image blocks immediately on top to the current image block but may be extended to a plurality of image blocks in a plurality of previous image block rows. Similarly, the approach may not be limited to the image blocks immediately to the left and/or to the right of the current image block but may be extended to a plurality of image blocks to the left and/or a plurality of image blocks to the right of the current image block in the current image block row.

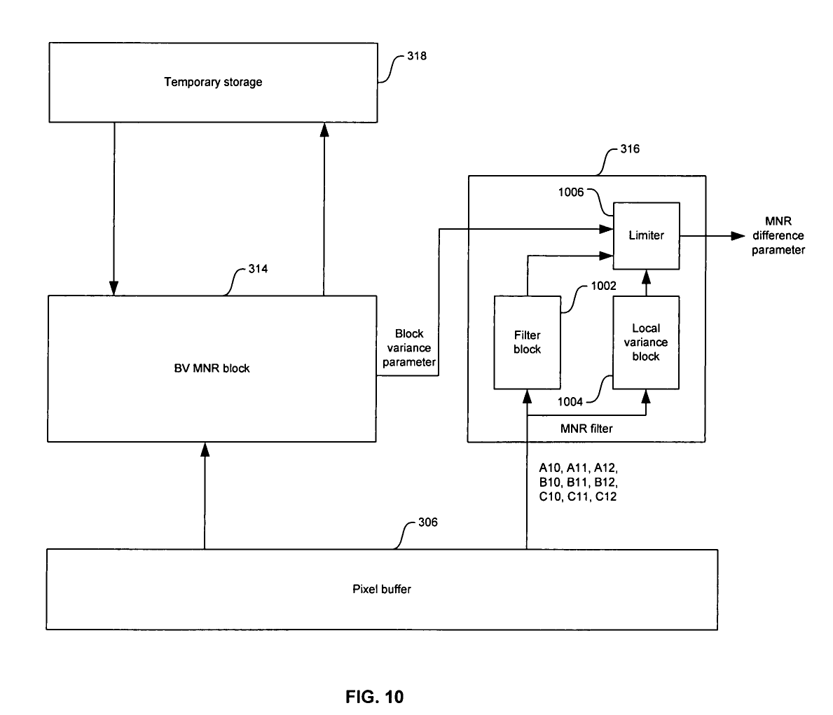

FIG. 10 is a block diagram illustrating an exemplary MNR filter block, in accordance with an embodiment of the invention. Referring to FIG. 10, there is shown the pixel buffer 306, the BV MNR block 314, the temporary storage block 318, and the MNR filter 316. The MNR filter 316 may comprise, for example, a filter block 1002, a local variance block 1004, and a limiter 1006. The filter block 1002 may comprise suitable logic, circuitry, and/or code that may be adapted to filter a portion of the image block. In this regard, the portion of the image block to be filtered may correspond to the pixels A10, A11, A12, B10, B11, B12, C10, C11, and C12 the pixel buffer 306 as described in FIG. 5. The pixel labeled B11 may correspond to the current pixel being processed for which mosquito noise artifacts may be reduced. Filtering may be performed on completed image blocks. In some instances, when an image block corresponds to the video picture boundary, filtering may not be performed on that image block. The set of filter values to be utilized may depend on whether the video signal is progressive or interlaced.

The local variance block 1004 may comprise suitable logic, circuitry, and/or code that may be adapted to determine a local variance parameter (local_var) in a portion of the image block. In this regard, the local variance parameter may be determined based on the portion of the image block that corresponds to the pixels A10, A11, A12, B10, B11, B12, C10, C11, and C12 the pixel buffer 306 as described in FIG. 5. The pixel labeled B11 may correspond to the current pixel being processed for which mosquito noise artifacts may be reduced.

The limiter 1006 may comprise suitable logic, circuitry, and/or code that may be adapted to determine the MNR difference parameter based on an original pixel value from the pixel buffer 306, a filtered pixel value from the filter block 1008, a relative weight parameter (m_rel), the block_var from the BV MNR block 314, and the local_var from the local variance block 1010. Once determined, the MNR difference parameter for a current pixel being processed may be transferred to the combiner 312 in FIG. 3.

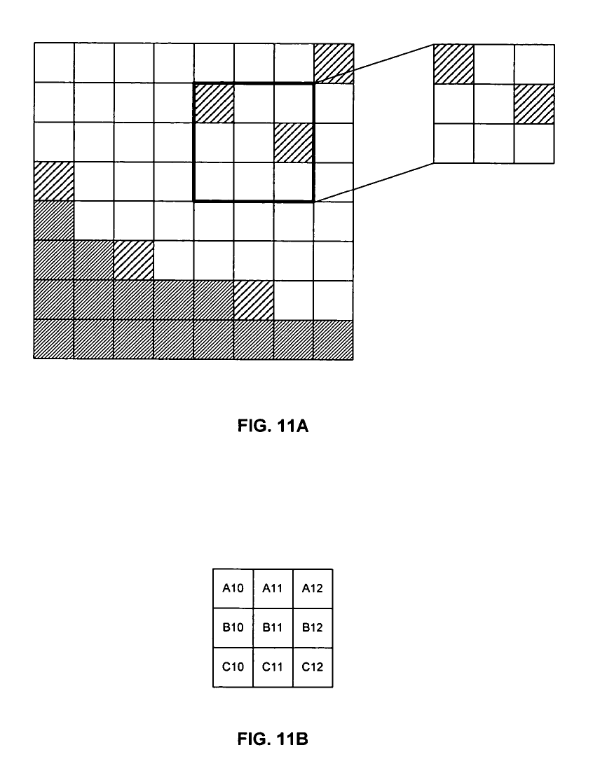

FIGS. 11A-11B illustrate an exemplary portion of the current image block for determining a local variance parameter, in accordance with an embodiment of the invention. Referring to FIG. 11A, there is shown a plurality of narrowly spaced hashed pixels that may correspond to a luma edge in the lower left corner of the image block. The widely spaced hashed pixels may correspond to mosquito noise artifacts that may occur in the image block as a result of MPEG coding, for example. The inset shown may correspond to a current portion of the image block being processed by the MNR filter 316. Referring to, FIG. 11B, there is shown the pixel labels in the pixel buffer 306 that correspond to the pixels in the current portion of the image block shown in the inset in FIG. 11A. In this regard, the pixel labeled B11 may correspond to the current pixel for which mosquito noise artifacts may be reduced.

When determining the local variance parameter in the local variance block 1004, a local maximum and a local minimum may be determined for the portion of the image block shown in FIG. 11B. For example, the local maximum may be determined by the expression
local_max=MAX[A10, A11, A12, B10, B11, B12, C10, C11, C12],
while the local minimum may be determined by the expression
local_min=MIN[A10, A11, A12, B10, B11, B12, C10, C11, C12].

The value of local_var may be determined as follows:

if ((spot_size_reduction) && (local_max < B11) ||
(local_min > B11)) {

local_var = local_max − local_min }

otherwise {

local_var = MIN[local_max − B11, B11 − local_min]},

where spot_size_reduction may correspond to a constraint parameter.

The filter block 1002 may be adapted to utilize a different set of values or filter coefficients when filtering interlaced and when filtering progressive content. For example, for progressive video images, the filter block 1002 may utilize the following filter coefficients (5, 8, 5, 8, 12, 8, 5, 8, 5)/64, where 64 is an exemplary scaling factor. In another example, for interlaced video images, the filter block 1002 may utilize the following filter coefficients (3, 6, 3, 12, 16, 12, 3, 6, 3)/64, where 64 is an exemplary scaling factor. The filter block 1002 may determine the filtered pixel values for the pixels in the image block and may transfer those values to the limiter 1004 for further processing.

The limiter 1006 may be adapted to determine a clamping limit (limit) to apply to a difference parameter that results from the original pixel value from the pixel buffer 306 and the filtered pixel value from the MNR filter block 1002. The clamping limit may be determined as follows:

limit = block_var − ( m_rel * local_var + 2 )/4,
if(block_var < m_core){

limit = limit + (m_core − block_var) }

if ( limit < 0 ) {

limit = 0 },

where m_core corresponds to a mosquito core limit parameter and block_var may correspond to the block variance parameter determined based on adjacent image blocks. The value of m_rel may depend on the relative weight to be given to the local_var in relation to the block_var. The value of m_rel may be determined based on at least a portion of the video signal information received by the DNR block 208 from the host processor 204. The value of m_core provides a threshold for at least partial removal of mosquito noise.

The limiter 1006 may also be adapted to determine a difference parameter (diff) that results from subtracting the original pixel value (orig_pixel) from the filtered pixel value (filt_pixel) determined by the filter block 1002. Once the value of diff has been determined, the limiter 1006 may determine the MNR difference parameter (MNR_diff) based on the following expression

$$\begin{matrix}MNR\_diff = CLAMP ( filt\_pixel - orig\_pixel , - limit , + limit ) \\ = CLAMP ( diff , - limit , + limit ) ,\end{matrix}$$

where the CLAMP operation limits the value of diff to a lower value given by −limit and to an upper value given by +limit. The value of MNR_diff may then be transferred to the combiner 312.

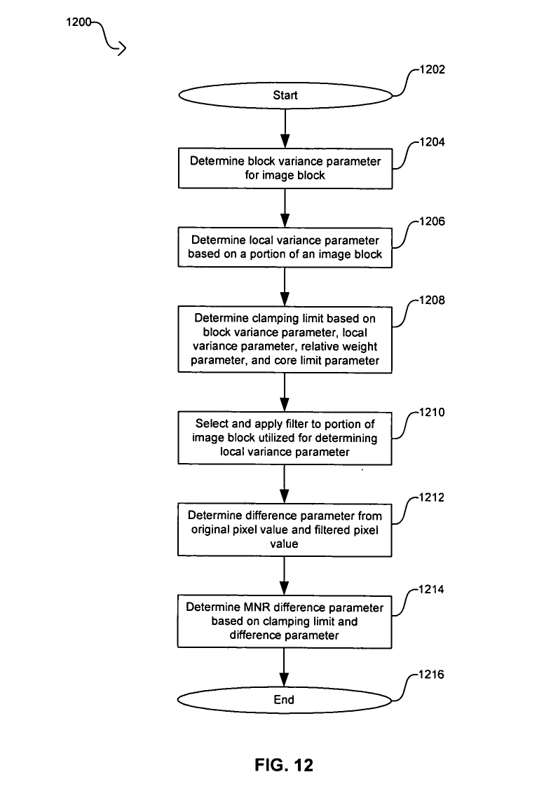

FIG. 12 is a flow diagram illustrating exemplary steps for the determination of an MNR difference parameter, in accordance with an embodiment of the invention. Referring to FIG. 12, after start step 1202, in step 1204, a block variance parameter may be determined for image blocks. The block variance parameter may be based on merging the block variance parameters of adjacent image blocks. In step 1206, a local variance parameter may be determined based on a portion of the current image block being processed. In step 1208, a clamping limit may be determined for the portion of the image block that corresponds to the local variance parameter. The clamping limit may be based on the block variance parameter, the local variance parameter, a relative weight parameter, and a mosquito core limit parameter.

In step 1210, an appropriate set of filter values or filter coefficients may be selected in accordance to whether the video signal is progressive or interlaced. In step 1212, a difference parameter may be determined based on the original pixel value and the filtered pixel value from step 1210. In step 1214, an MNR difference parameter may be determined by applying the clamping limit determined in step 1208 to the difference parameter determined in step 1212. After determining the MNR difference parameter for all pixels in a current video image, the exemplary steps may proceed to end step 1216.

In an embodiment of the invention, a machine-readable storage having stored thereon, a computer program having at least one code section for image processing, the at least one code section being executable by a machine for causing the machine to perform steps for mosquito noise reduction in MPEG-coded video images.

The approach described herein may provide an effective and simplified solution that may be implemented to reduce the presence of mosquito noise artifacts without any perceptible degradation in video quality.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for image processing, the method comprising:
determining edge parameters for a selected image block;
determining a local variance for a plurality of selected portions of said selected image block;
filtering said selected image block by filtering pixels in said plurality of selected portions of said selected image block via a programmable filter that handles progressive content and interlaced content; and
limiting a value of at least a portion of said filtered pixels in said plurality of selected portions of said selected image block based on said determined edge parameters and said determined local variance.

2. The method according to claim 1, further comprising determining a block variance parameter for said selected image block based a horizontal variance parameter for said selected image block and a vertical variance parameter for said selected image block.

3. The method according to claim 2, further comprising determining said block variance parameter to be proportional to a sum of said horizontal variance parameter for said selected image block and said vertical variance parameter for selected said image block.

4. The method according to claim 2, further comprising serially determining said horizontal variance parameter for said selected image block and said vertical variance parameter for said selected image block.

5. The method according to claim 2, further comprising determining a clamping limit for said filtered pixels based on said determined block variance parameter, said determined local variance for said plurality of selected portions of said selected image block, a relative weight parameter, and a mosquito core limit parameter.

6. The method according to claim 2, further comprising determining said block variance parameter based on at least one block variance parameter in a current image block row, at least one block variance parameter in a previous image block row, and a merge parameter.

7. The method according to claim 2, further comprising determining said block variance parameter based on at least one block variance parameter in a current image block row and a merge parameter.

8. The method according to claim 1, further comprising determining a difference parameter for each of said filtered pixels in said plurality of selected portions of said selected image block.

9. The method according to claim 1, further comprising determining a mosquito noise reduction difference parameter for at least a portion of said limited filtered pixels in said plurality of selected portions of said selected image block.

10. The method according to claim 1, further comprising determining said local variance parameter based on a local maximum and a local minimum.

11. The method according to claim 1, further comprising generating three output parallel lines of pixel luma information to construct at least a portion of said selected image block when in a high definition (HD) video mode is selected.

12. The method according to claim 1, further comprising generating six output parallel lines of pixel luma information to construct at least a portion of said selected image block when in a standard definition (SD) video mode is selected.

13. A system for image processing, the system comprising:
circuitry that determines edge parameters for a selected image block;
circuitry that determines a local variance for a plurality of selected portions of said selected image block;
circuitry that filters said selected image block by filtering pixels in said plurality of selected portions of said selected image block via a programmable filter that handles progressive content and interlaced content; and
circuitry that limits a value of at least a portion of said filtered pixels in said plurality of selected portions of said selected image block based on said determined edge parameters and said determined local variance.

14. The system according to claim 13, further comprising circuitry that determines a block variance parameter for said selected image block based a horizontal variance parameter for said selected image block and a vertical variance parameter for said selected image block.

15. The system according to claim 14, further comprising circuitry that determines said block variance parameter to be proportional to a sum of said horizontal variance parameter for said selected image block and said vertical variance parameter for said selected image block.

16. The system according to claim 14, further comprising circuitry that serially determines said horizontal variance parameter for said selected image block and said vertical variance parameter for said selected image block.

17. The system according to claim 14, further comprising circuitry that determines a clamping limit for said filtered pixels based on said determined block variance parameter, said determined local variance for said plurality of selected portions of said selected image block, a relative weight parameter, and a mosquito core limit parameter.

18. The system according to claim 14, further comprising circuitry that determines said block variance parameter based on at least one block variance parameter in a current image block row, at least one block variance parameter in a previous image block row, and a merge parameter.

19. The system according to claim 14, further comprising circuitry that determines said block variance parameter based on at least one block variance parameter in a current image block row and a merge parameter.

20. The system according to claim 13, further comprising circuitry that determines a difference parameter for each of said filtered pixels in said plurality of selected portions of said selected image block.

21. The system according to claim 13, further comprising circuitry that determines a mosquito noise reduction difference parameter for at least a portion of said limited filtered pixels in said plurality of selected portions of said selected image block.

22. The system according to claim 13, further comprising circuitry that determines said local variance parameter based on a local maximum and a local minimum.

23. The system according to claim 13, further comprising circuitry that generates three output parallel lines of pixel luma information to construct at least a portion of said selected image block when in a high definition (HD) video mode is selected.

24. The system according to claim 13, further comprising circuitry that generates six output parallel lines of pixel luma information to construct at least a portion of said selected image block when in a standard definition (SD) video mode is selected.
